(19) United States
(12) Patent Application Publication
(10) Pub. No.: US 2026/0329683 A1
(43) Pub. Date: Oct. 22, 2026

(54) 3D ARBITRARY SAFETY CRITICAL HMI

(71) Applicant: DISTI, LLC, Orlando, FL (US)

(72) Inventors: Christopher Van Duyne, Orlando, FL (US); Christopher Giordano, Orlando, FL (US); Nathan Giroux, Orlando, FL (US)

(73) Assignee: DISTI, LLC, Orlando, FL (US)

(21) Appl. No.: 19/654,983

(22) Filed: Apr. 22, 2026

Related U.S. Application Data
(60) Provisional application No. 63/792,809, filed on Apr. 22, 2025.

(51) Int. Cl. G06F 11/07; G06T 15/00

(52) U.S. Cl. CPC G06F 11/0772; G06F 11/0721; G06T 15/005; G06T 2210/52

(57) ABSTRACT

A data processing system configured for dual rendering verification of three-dimensional safety-critical graphical content comprises a host computing system. The host computing system comprises one or more computers each with memory and at least one processor, a display system, and 3D content stored within the memory of at least one of the one or more computers. A first rendering path comprises a Hardware Rendered Application (HRA) for rendering 3D content using a graphics processing unit (GPU) to generate a first buffer. A second rendering path comprises a Software Rendered Application (SRA) for generating a second buffer for comparison against the first buffer. A buffer comparison application that includes a fuzzy compare module for detecting discrepancies between the first and second buffers.

### CROSS-REFERENCE TO RELATED APPLICATION(S)

The present application claims priority to U.S. Provisional Patent Application No. 63/792,809, entitled 3D ARBITRARY SAFETY CRITICAL HMI, filed on Apr. 22, 2025, the entirety of which is incorporated herein by reference.

### FIELD OF THE INVENTION

This invention relates to safety-critical display systems and methods of use thereof, and more particularly, to systems and methods for verifying the correct rendering of three-dimensional graphical content in automotive human-machine interfaces and other safety-critical applications.

### BACKGROUND OF THE INVENTION

Traditionally, safety-critical data in Digital Human Machine Interfaces (HMIs) in automobiles are increasingly used to display information to drivers, including safety-critical information where errors could risk human lives. It is therefore imperative to detect rendering errors in safety-critical display data to ensure that erroneous information is not shown to the driver.

Traditionally, safety-critical data in automotive displays has been represented as two-dimensional (2D) icons at fixed or knowable locations on the display. The state of the art for verifying that these 2D icons are rendered correctly involves performing a Cyclical Redundancy Check (CRC) on each area in the display frame buffer and comparing the calculated CRC against an expected, pre-calculated CRC value.

This traditional 2D approach, however, significantly limits the type of safety-critical content that can be displayed to the driver. Of particular challenge is displaying three-dimensional (3D) graphical data with arbitrary positions, rotations, and scales while ensuring ASIL requirements. The continuous nature of position, rotation, and scale data makes the pre-calculated CRC approach unusable because the number of possible permutations of data becomes astronomically large, making it impractical to pre-calculate and store CRC values for all possible states.

One existing approach for deploying 3D safety-critical content is to create software that is formally proven to be bug-free and execute it on hardware and drivers that are similarly proven to be bug-free. This approach is commonly used in certified avionics applications. However, the challenge with automotive display systems is that the hardware typically does not meet these stringent certification requirements due to cost constraints. Automotive manufacturers must balance safety requirements with economic realities, and the cost of fully certified graphics processing hardware is often prohibitive for mass-market vehicles.

Therefore, there exists a need for a system and method that enables the display of three-dimensional safety-critical graphical content in automotive and other safety-critical applications while providing verification that the content is being rendered correctly, without requiring prohibitively expensive certified graphics hardware.

### SUMMARY OF THE INVENTION

Embodiments of the present invention are directed to systems and methods for implementing a functional safety capable graphical user interface containing arbitrary 3D elements representing safety-critical data which can be automatically or programmatically verified.

Automotive displays increasingly require three-dimensional safety-critical graphics with arbitrary positions, rotations, and scales, but traditional CRC-based verification is impractical for such continuous parameter spaces, and certified graphics hardware is prohibitively expensive. This invention solves this problem through redundant rendering with diverse implementation: a fast GPU path renders content for display while a certified software renderer independently renders the same content for verification. Fuzzy comparison algorithms detect meaningful discrepancies between outputs, accommodating inherent variations between rendering implementations. The software renderer employs either partial frame rendering—checking different screen regions each frame—or delayed full-frame comparison to match GPU performance within required fault detection intervals. Hardware watchdogs monitor system operation. When a failure is detected the system-specific failure logic is activated, enabling advanced 3D automotive displays at automotive-grade costs.

The present invention provides a system and method for verifying the correct rendering of three-dimensional safety-critical graphical content using dual rendering paths with independent verification. The system addresses the limitations of prior art by enabling arbitrary 3D content with continuous position, rotation, and scale parameters to be safely displayed without requiring fully certified graphics hardware.

The invention uses two parallel rendering paths: a Hardware Rendered Application (HRA) that utilizes a Graphics Processing Unit (GPU) for fast rendering to the display, and a Software Rendered Application (SRA) that performs CPU-based software rendering for verification purposes. Both applications receive identical input data and render the same 3D content, but through different rendering pipelines.

The system comprises: stored 3D content created by a safety-certifiable tool; two runtime instances of the 3D content that receive identical network data; a first rendering path utilizing a GPU through non-certified drivers to produce a GPU rendered buffer that is displayed to the user; a second rendering path utilizing a certified software renderer executing on a CPU to produce a software rendered buffer; an image comparison application that compares between the two rendered buffers or portions thereof; failure logic that is triggered when the comparison detects a discrepancy exceeding acceptable thresholds; and a hardware watchdog that monitors system operation and triggers failure logic if components fail to respond within required time intervals.

The key insight is that by using safety-certified software components (the 3D content, runtime library, and software renderer) in both paths, but only requiring the GPU path to be fast enough for display, the system can detect failures in the non-certified GPU hardware and drivers by comparing against the trusted software-rendered output.

To address the performance disparity between GPU and CPU rendering, the invention provides two primary implementation options. In a first option, the software renderer renders only a smaller rectangular portion of the frame for each display frame, with the rendered area changing each frame such that the entire display area is verified within a specified Fault Detection Time Interval (FDTI). In a second option, the software renderer renders complete frames at a slower rate, with each complete software-rendered frame compared against a stored copy of the corresponding GPU-rendered frame. This option would also verify within the FDTI.

The comparison between rendered outputs uses a fuzzy comparison algorithm rather than exact pixel matching, because different renderers implementing the same graphics standard are not guaranteed to produce identical pixel values. The fuzzy comparison determines whether the rendered outputs are sufficiently similar that any differences would not mislead the user.

The system architecture ensures independence between the two rendering paths by executing them on separate hardware (separate cores or separate processors) that do not share common failure modes. When a discrepancy is detected that exceeds acceptable thresholds, or when the watchdog detects a system failure, the failure logic is activated, typically blanking the display to prevent showing incorrect safety-critical information to the user.

According to one or more embodiments, a data processing system configured for dual rendering verification of three-dimensional safety-critical graphical content comprises a host computing system. The host computing system comprises one or more computers each with memory and at least one processor; a display system; and 3D content stored within the memory of at least one of the one or more computers. A first rendering path comprises a Hardware Rendered Application (HRA) for rendering 3D content using a graphics processing unit (GPU) to generate a first buffer. A second rendering path comprises a Software Rendered Application (SRA) for generating a second buffer for comparison against the first buffer. A buffer comparison application that includes a fuzzy compare module for detecting discrepancies between the first and second buffers.

In one aspect, the first rendering path and the second rendering path are independent hardware platforms.

In another aspect, the first rendering path and the second rendering path are implemented on separate cores of the at least one processor.

In another aspect, the first buffer is a buffer of color pixel values representing a rendered frame.

In another aspect, the first buffer is stored within shared memory accessible to both the display system and the buffer comparison application.

In another aspect, the first buffer is transmittable to the display system to display rendered content a user.

In another aspect, the 3D content comprises arbitrary three-dimensional objects with variable positions, rotations, scales, and properties that change dynamically based on vehicle state.

In another aspect, during runtime two separate instances of 3D content are created on the HRA and SRA respectively. The two separate instances each receive identical network data, which provides live information indicative of at least one of vehicle state, sensor readings, and navigation information.

According to another embodiment, a method of verifying three-dimensional safety-critical graphical content, comprises: running two separate instances of three-dimensional safety-critical content stored within a memory of a host computing system; generating a first buffer using a Hardware Rendered Application (HRA); generating a second buffer using a Software Rendered Application (SRA); comparing the second buffer to the first buffer; identifying any discrepancies between the second buffer and the first buffer; and if any discrepancies are identified, triggering a failure logic module.

In one aspect, the HRA is part of a first rendering path and SRA is part of a second rendering path.

In another aspect, the first and second rendering paths are independent hardware platforms implemented on separate cores of at least one processor of the host computing system.

In another aspect, the first buffer is a buffer of color pixel values representing a rendered frame.

In another aspect, the first buffer is stored within shared memory accessible to both the display system and the buffer comparison application.

In another aspect, the host computing system comprises a display system.

In another aspect, the method further comprises blanking the display system when the failure logic module is triggered.

In yet another embodiment, a host computing system configured for dual rendering verification of three-dimensional safety-critical graphical content. The system comprises: one or more computers each with memory and at least one processor; and 3D content stored within the memory of at least one of the one or more computers. A first rendering path comprises a Hardware Rendered Application (HRA) for rendering 3D content using a graphics processing unit (GPU) to generate a first buffer. A second rendering path comprises a Software Rendered Application (SRA) for generating a second buffer for comparison against the first buffer.

In one aspect, the method further comprises a buffer comparison application that includes a fuzzy compare module for detecting discrepancies between the first and second buffers.

In another aspect, the method further comprises a display system configured to display alerts to a user during operation of an automobile.

In another aspect, the method further comprises a watchdog system configured to monitor operation of the buffer comparison application.

In another aspect, the watchdog system comprises a hardware timer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

For a fuller understanding of the nature and objects of the invention, reference should be had to the following detailed description taken in connection with the accompanying drawings in which:

FIG. 1 is a system architecture diagram showing the overall configuration of the dual rendering verification system, including the HRA and SRA paths, the comparison application, and associated components, in accordance with principles of the present application;

FIG. 2 is a diagram illustrating the partial frame rendering approach (Option 1), showing a GPU rendered buffer with multiple rectangular regions and a software rendered buffer rendering a single selected region for comparison, with the region selection changing each frame to achieve full coverage within the Fault Detection Time Interval, in accordance with principles of the present application;

FIG. 3 is a flowchart illustrating the overall process flow of the dual rendering verification system, from receiving network data through rendering, comparison, and failure detection, in accordance with principles of the present application;

FIG. 4 is a timing diagram showing the relationship between HRA frame rendering, SRA partial region rendering, and comparison operations for the partial frame rendering approach (Option 1), in accordance with principles of the present application;

FIG. 5 is a timing diagram showing the relationship between HRA frame rendering, SRA full frame rendering, and delayed comparison operations for the full frame delayed approach (Option 2), in accordance with principles of the present application;

FIG. 6 is a block diagram showing the hardware architecture with separate processing cores or processors for the HRA and SRA, illustrating the independence of the rendering paths, in accordance with principles of the present application;

FIG. 7 is a diagram illustrating the rectangular region selection pattern for partial frame rendering, showing how different regions are prioritized based on their Fault Detection Time Interval requirements, in accordance with principles of the present application;

FIG. 8 is a flowchart showing the image comparison process, including receiving the GPU and software rendered buffers, performing the comparison algorithm, applying thresholds, and triggering failure logic when discrepancies are detected, in accordance with principles of the present application; and

FIG. 9 is a block diagram showing the failure detection and response system, including the hardware watchdog, failure logic, and display blanking mechanism, in accordance with principles of the present application.

### DETAILED DESCRIPTION

The present invention advantageously provides systems and methods for verifying the correct rendering of three-dimensional graphical content in automotive human-machine interfaces and other safety-critical applications, in accordance with principles of the present disclosure described herein.

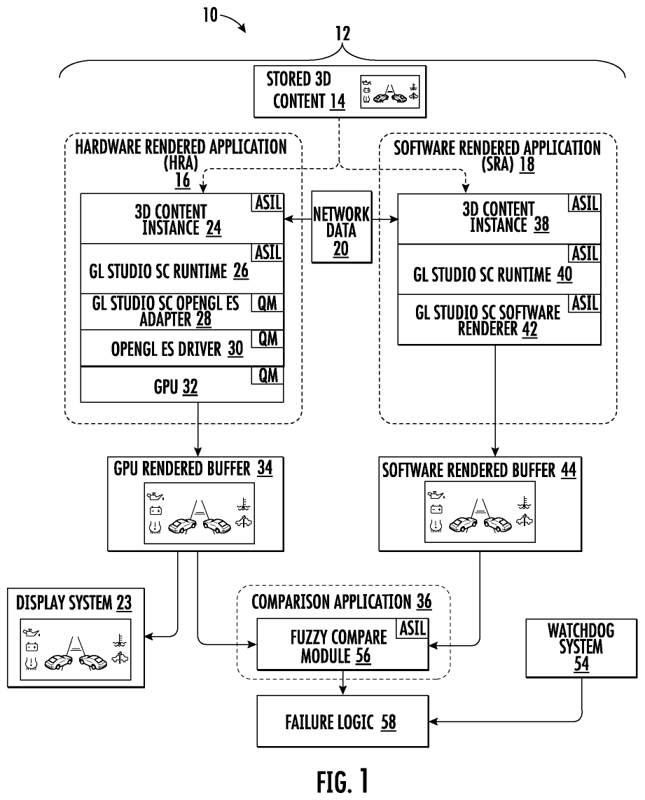

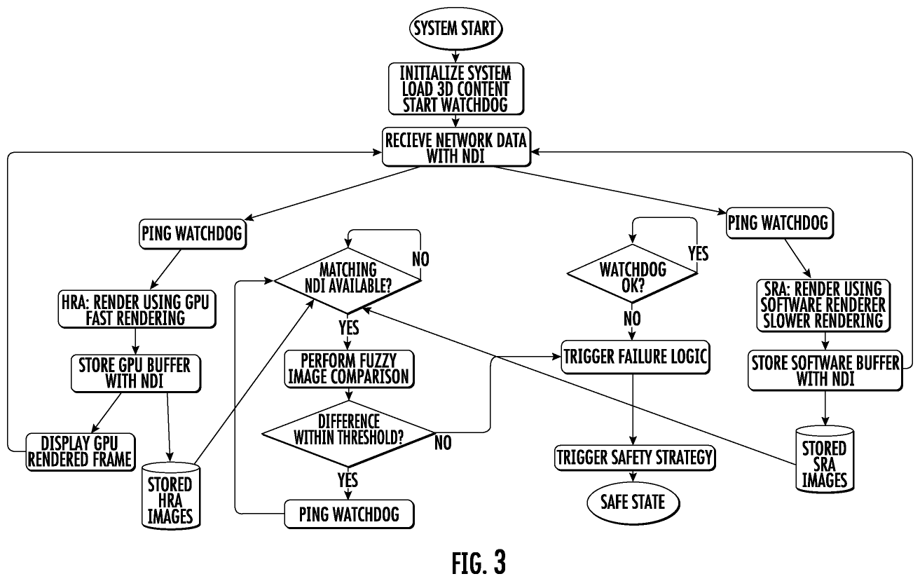

Now referring to FIGS. 1-9, a data processing system configured for dual rendering verification of three-dimensional safety-critical graphical content designated as generally “10” and described herein provides a mechanism to allow for 3D safety-critical graphical content to be displayed to the driver while assuring that it is being rendered correctly. In particular, the system 10 provides a comprehensive system for safely displaying three-dimensional safety-critical graphical content in automotive displays and other safety-critical applications. The system 10 architecture, as shown in FIG. 1, comprises two parallel rendering paths that process identical input data to produce visual outputs that are compared to verify correct rendering.

The fundamental principle underlying the invention is the use of redundant rendering through diverse implementation. Rather than relying on a single rendering path that would require expensive certified hardware throughout, the system uses a fast GPU-based rendering path for display output and a slower but fully certified software rendering path for verification. By comparing the outputs of these two independent paths, the system can detect failures in the non-certified GPU hardware and drivers.

The diagram illustrated in FIG. 1 shows a general configuration followed by a description of each element below:
“ASIL”—This term refers to the Automotive Safety Integrity Level defined by ISO26262.
“3D Content Stored”—This term refers to what is created in GL STUDIO® provided by DiSTI (or some HMI design tool) which is the content to be displayed to the operator which may contain 3D content. The 3D Content Stored has been generated by an ASIL D tool.
“3D Content Instance”—This term refers to a runtime instance of the 3D Content Stored. This is generally a compiled application but could be something that dynamically loads the 3D Content Stored. There are two instances. One of the two is going to be rendered with a GPU and the other with a software renderer on a CPU.
“Network Data”—This term refers to live data provided to the 3D Content Instance. This data is used for the instance to know what to show. Note that both instances are provided with the same data.
“GL Studio SC Runtime”—This term refers to a support library for the 3D Content Instance. It is responsible for making OpenGL Safety Critical (OpenGL SC) calls to represent the current state of the 3D Content Instance. The same GL Studio SC Runtime code is used on both the Hardware Rendered Application (HRA) and Software Rendered Application (SRA). The GL Studio SC Runtime is certifiable to ASIL D (the highest level).

“GL Studio SC OpenGL ES Adapter”—This term refers to a library which implements a portion of the OpenGL SC standard and renders using OpenGL Embedded System (OpenGL ES).

“OpenGL ES Driver”—This term refers to a driver that accepts OpenGL ES API calls and controls the GPU. It may or may not be ASIL certifiable.

“GL Studio SC Software Renderer”—This term refers to a software rendered that also accepts OpenGL SC API calls, but instead of utilizing a GPU to render, it performs all calculations in the CPU and renders output directly. Notably, while this accepts OpenGL SC API calls, it is only written and certifiable for a small subset of calls, which GL Studio SC Runtime needs to render content.

“GPU”—This term refers to an accelerated Graphics Processor Unit that efficiently draws the content provided by the OpenGL SC Driver.

“GPU Rendered Buffer”—This term refers to the output of the GPU which is a buffer of color pixels.

“Software Rendered Buffer”—This term refers to the output of the GL Studio SC Software Renderer which is also a buffer of color pixels.

“Fuzzy Compare”—This term refers to the comparison performed between the two buffers, or portions of the buffers to determine that they are similar enough. The choice of algorithm to use here is based on performance considerations and the required level of precision.

“Failure Logic”—This term refers to the logic that is run when the Fuzzy Compare Buffers determines there is a discrepancy.

“Hardware Watchdog”—This term refers to a hardware mechanism that is configured to automatically trigger the failure logic if it has not been pinged recently enough. This is used to ensure that applications are running.

“Display”—This term refers to the output of the system which is shown to the user and is assured safe.

The 3D Content, GL Studio SC Runtime, and GL Studio SC Software Renderer are all certifiable code so they can be trusted to operate correctly. However, the hardware on which they run, the OpenGL driver, and the GPU are (generally) not certifiable enough to guarantee that there are no faults. To address this issue, in one or more embodiments the two software applications are run on separate hardware so that the accelerated instance and the software instance are run on independent hardware that do not share many failure modes. The independence of failure modes allows the overall results to be more reliable and trusted.

### 3D Content Creation and Storage

Continuing to refer to FIG. 1, the system 10 comprises a host computing system 12. The processes of host computing system 12 begins with Stored 3D Content 14, which represents the graphical content to be displayed to the driver (which can include two-dimensional (2D) content). This content is created using a safety-certifiable tool, such as GL Studio or similar authoring environments capable of producing content that meets automotive safety integrity requirements. The 3D content may include arbitrary three-dimensional objects with variable positions, rotations, scales, and other properties that change dynamically based on vehicle state and other inputs.

The content creation tool must be certifiable to the Automotive Safety Integrity Level (ASIL) assigned to the content to display. This certification ensures that the tool itself does not introduce errors into the content.

The Stored 3D Content 14 is typically verified for integrity when loaded into memory of the host computing system 12, using techniques such as CRC to detect any corruption of the stored content. This verification ensures that the content being instantiated matches the certified content that was created by the authoring tool. This is to deal with the possibility that ASIL level hardware could have corrupted the content before or while it is being loaded into memory.

### Runtime Instances and Network Data

At runtime, two separate instances of the 3D content are created: one for the Hardware Rendered Application (HRA) 16 and one for the Software Rendered Application 18. Both instances are functionally identical and are created from the same Stored 3D Content 14. The instances may be compiled applications or may dynamically load the stored content, depending on the implementation requirements.

Both instances receive identical Network Data 20, which provides live information about vehicle state, sensor readings, navigation information, and other dynamic data that determines what should be displayed. Network Data 20 includes identifiers such as timestamps or sequence numbers (referred to as Network Data Identifiers or NDIs) that allow the system 12 to track which data was used to generate each rendered frame.

The provision of identical network data to both instances is critical for the comparison to be valid. If the instances were rendered based on different input data, differences in the output would be expected and would not indicate a rendering failure.

Network Data 20 is typically transmitted using automotive networking protocols that include error detection mechanisms such as CRCs to ensure data integrity. If the underlying networking system allows out-of-order arrival of data, the system is configured to discard outdated updates and always use the most recent available data. This ensures that both rendering instances work with current information.

### Hardware Rendered Application (HRA) Path

The HRA 16 represents the fast-rendering path that produces the output shown to a user (e.g., driver or operator of an automobile) on the display 22 of display system 23. As shown in FIG. 1, the HRA 16 path includes several components that work together to efficiently render the 3D content using graphics acceleration hardware.

The 3D Content Instance 24 in the HRA 16 receives Network Data 20 and determines the current state of all graphical elements to be displayed. This instance is supported by the GL Studio SC Runtime 26, which is a library certified to ASIL D that translates the content state into graphics API calls. Specifically, the GL Studio SC Runtime 26 makes OpenGL SC (Safety Critical) API calls that represent the current state of the 3D content.

OpenGL SC is a safety-critical subset of the OpenGL graphics standard, designed for use in avionics and other safety-critical applications. It provides a well-defined, implementable subset of graphics functionality suitable for certification.

The OpenGL SC calls from the runtime are received by the GL Studio SC OpenGL ES Adapter 28, which implements a portion of the OpenGL SC standard but renders using OpenGL ES (Embedded Systems), a more widely supported graphics API. This adapter translates the safety-critical API calls into calls that can be processed by standard automotive graphics hardware.

The OpenGL ES Driver 30 receives the OpenGL ES API calls and controls the GPU (Graphics Processing Unit) 32 to perform the actual rendering operations. The GPU 32 is specialized hardware configured to efficiently perform the mathematical operations required for 3D graphics rendering, including vertex transformations, rasterization, texture mapping, and pixel shading.

Critically, neither the OpenGL ES Driver 30 nor the GPU 32 itself needs to be certified to automotive safety standards. These components are marked as “QM” (Quality Managed) in FIG. 1, indicating they are managed for quality but not certified to ASIL levels. This is a key cost-saving aspect of the present system, as certified graphics hardware would be prohibitively expensive for automotive applications.

The output of the GPU 32 is the GPU Rendered Buffer 34, which is a buffer of color pixel values representing the rendered frame. This buffer is typically stored in shared memory 35 accessible to both the display system 22 and the Comparison Application 36. In some implementations, the GPU 32 may be configured to write directly to a shared memory region, or the buffer may be transferred using Direct Memory Access (DMA) or other efficient transfer mechanisms.

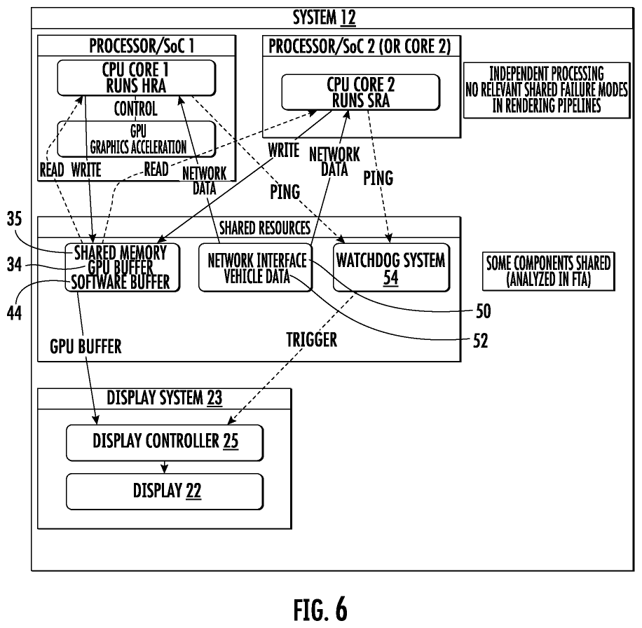

The GPU Rendered Buffer 34 proceeds to the display system 22, which shows the rendered content to the user. The display system 22 itself may include additional ASIL-certified components or verification mechanisms to ensure proper operation of the display hardware. As shown in FIG. 6, the display system 23 comprises a display controller 25 and the physical display 22.

### Software Rendered Application (SRA) Path

The Software Rendered Application represents 18 the verification rendering path that produces a trusted output for comparison against the GPU-rendered output. As shown in FIG. 1, the SRA 18 path uses certified software components throughout to ensure that its output can be trusted as correct.

Like the HRA 16, the SRA 18 includes a 3D Content Instance 38 that receives the same Network Data 20 and determines the current state of graphical elements. This instance is also supported by the GL Studio SC Runtime 40, which makes the same OpenGL SC API calls as in the HRA 16 path. Importantly, the same GL Studio SC Runtime 40 code is used in both paths, ensuring consistency in how the content state is translated to graphics API calls.

The use of identical runtime code in both paths is important because it means any bugs in the runtime would affect both paths equally and would not be detected by comparison. However, since the runtime is certified to ASIL D, it can be trusted to operate correctly, and the comparison is focused on detecting failures in the non-certified GPU hardware, drivers, memory and other hardware.

In the SRA 18 path, the OpenGL SC API calls are received directly by the GL Studio SC Software Renderer 42, which is a CPU-based software implementation of the graphics rendering pipeline. Unlike the HRA 16 path, which uses hardware acceleration, the SRA 18 performs all rendering calculations in software running on the CPU (not shown) of the host computing system 10.

The GL Studio SC Software Renderer 42 is certified to ASIL D, but importantly, it only needs to implement the subset of OpenGL SC functionality that is actually used by the GL Studio SC Runtime 40. This focused scope makes certification more practical than certifying a full software graphics driver.

The software rendering is inherently much slower than GPU-based rendering because CPUs are not optimized for the parallel operations required for graphics rendering. A modern GPU can perform thousands of operations simultaneously, while a CPU typically processes operations more sequentially. This performance difference is addressed by the partial rendering and delayed comparison strategies described below.

The output of the software renderer is the Software Rendered Buffer 44, which, like the GPU Rendered Buffer 34, is a buffer of color pixel values. This buffer is also typically stored in shared memory accessible to the Comparison Application 36.

### Hardware Independence

A critical aspect of the system 12 architecture is the independence between the HRA 16 and SRA 18 hardware platforms. The two rendering paths are executed on separate hardware that does not share relevant common failure modes. This independence is essential for the verification approach to be effective.

As shown in FIG. 6, the HRA 16 and SRA 18 may be implemented on separate processor cores within the system 10 that is a multi-core system, or on entirely separate processors or system-on-chip devices. The choice of hardware configuration is primarily driven by performance considerations. Since the SRA 18 is computationally intensive, running it on a separate core or processor prevents it from interfering with the HRA's 16 ability to render frames at the required frame rate for smooth display.

The degree of hardware sharing affects the types of failures that can be detected. Components that are shared between the HRA 16 and SRA 18, such as shared memory 35, GPU Buffer 46, Software Buffer 48, data buses, power supplies, network interfaces 50, vehicle data 52, and the hardware Watchdog System 54 (discussed in more detail below) timer, represent potential common failure modes that must be analyzed as part of the system's Fault Tree Analysis (FTA). The more hardware independence that can be achieved, the broader the range of failures that can be detected.

In practice, some sharing is inevitable in an automotive system. The key is to ensure that the critical rendering pipelines—particularly the GPU 32 and its driver versus the software renderer—are sufficiently independent that failures in one do not affect the other, or that common failures that can occur will be detected by the hardware watchdog.

### Frame Synchronization and Data Tracking

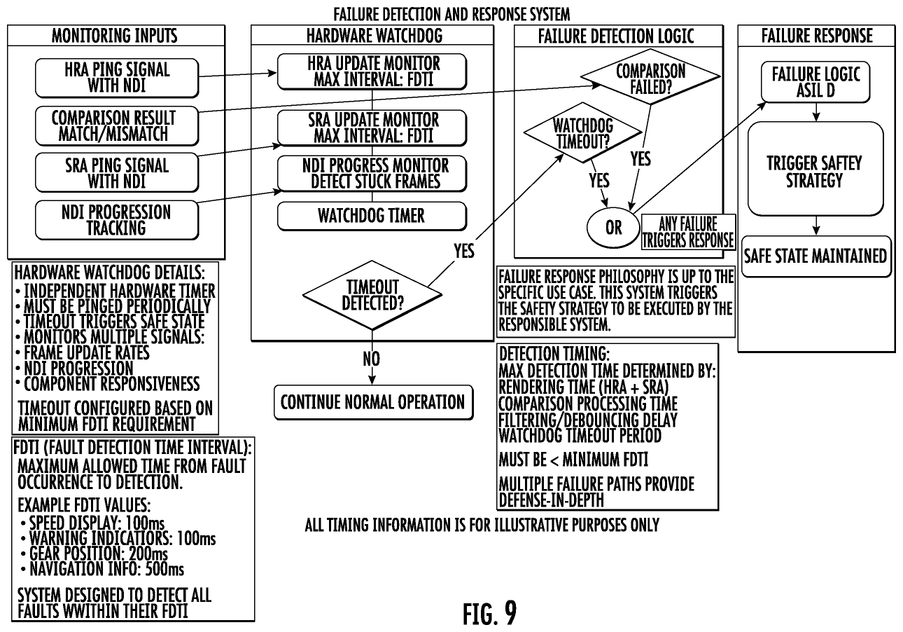

For the comparison between HRA 16 and SRA 18 outputs to be valid, the system 10 must ensure that corresponding frames are compared—that is, frames that were rendered based on the same input data. This is accomplished through the Network Data Identifier (NDI) system, as illustrated in the Failure Detection and Response System depicted in FIG. 9. As shown in FIG. 9, the hardware Watchdog System 54 (discussed in more detail below) ensures that valid updates are occurring, and if they are not, it triggers the failure detection logic. The Watchdog System 54 is expecting updates from multiple monitoring inputs, each with potentially different required timeouts.

Each set of Network Data 20 includes an identifier, which may be a timestamp, sequence number, or other unique identifier. When the HRA 16 and SRA 18 render frames, they associate the resulting rendered buffers with the Network Data Identifier (NDI) of the input data that was used. The Comparison Application 36 only compares buffers that have matching NDIs, ensuring that any differences are due to rendering discrepancies rather than different input data.

This approach handles the asynchronous nature of the two rendering paths. The HRA 16 renders frames quickly for display, while the SRA 18 renders more slowly for verification. By tracking NDIs, the system 10 can match up corresponding frames even though they are rendered at different times.

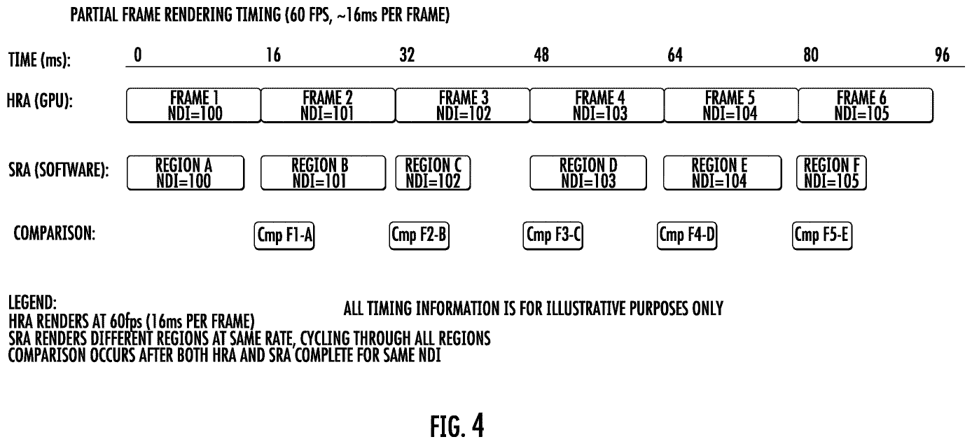

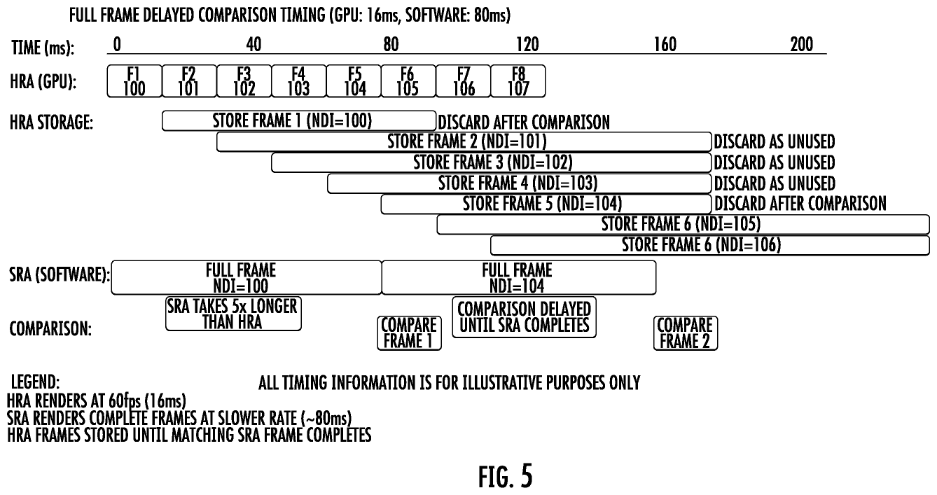

The timing relationships are illustrated in FIGS. 4 and 5 for the two different rendering approaches. In both cases, the HRA 16 continuously renders frames based on the latest available Network Data 20, while the SRA 18 renders at its own pace, and comparisons are performed when matching frames are available. In FIG. 4, the HRA rendered frames occur at fixed intervals (usually) in sync with the Display Controller 25. The SRA frames are started at the same time as the HRA frames, but since they are only rendering a portion of the whole screen they can (generally) complete their draw withing the HRA frame. Their results can then be compared immediately after the HRA and SRA frames are complete.

FIG. 5 shows the full-frame option. In this case, since the SRA will take longer than the HRA 16 to render some HRA frames will be discarded without comparison, as the system checks only the most recent data. As soon as an SRA frame is completed, it is immediately compared with its corresponding stored HRA frame, and all previous HRA frames are discarded. The system design will ensure that within the specified Fault Detection Time Interval (FDTI), all safety-critical content has been verified.

### Image Comparison

One notable aspect of the present invention is the use of fuzzy comparison rather than exact pixel-by-pixel comparison between the GPU and software rendered buffers. This approach is necessary because the OpenGL standard, including OpenGL SC, does not guarantee that different implementations will produce identical pixel values for the same input.

Graphics rendering involves numerous floating-point calculations, and different hardware and software implementations may perform these calculations with different precision or rounding behavior. Additionally, different implementations may use different algorithms for operations like texture filtering or anti-aliasing, leading to slightly different results.

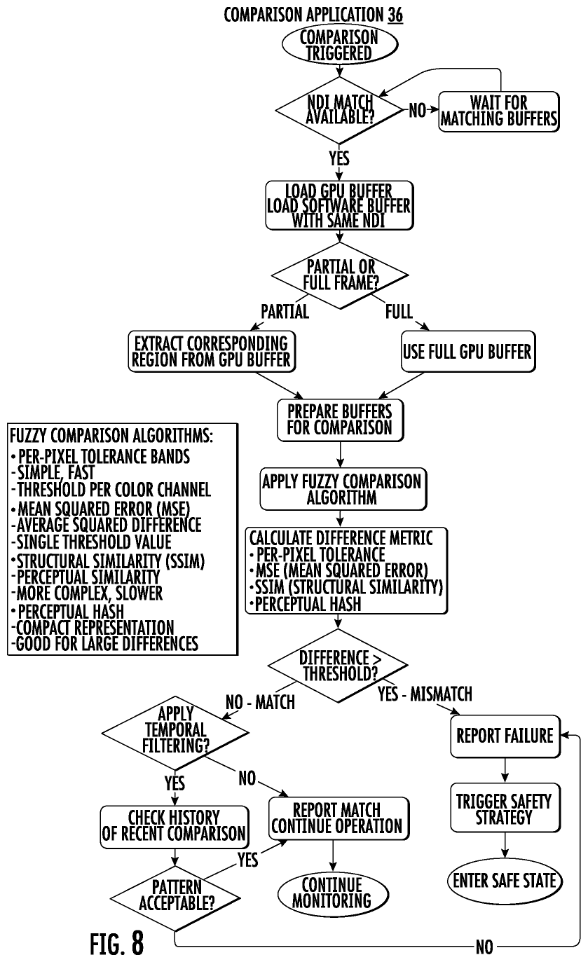

The Comparison Application 36 and its image comparison process are shown in FIGS. 1 and 8. The Comparison Application 36 implements a fuzzy image comparison algorithm (Fuzzy Compare module 56 (see also FIG. 8)) that determines whether two rendered images are “close enough” that any differences would not mislead the user. The specific algorithm used is selected based on performance requirements and the acceptable level of precision for the application.

Candidate algorithms for fuzzy comparison include:
Pixel-wise tolerance bands, where each pixel in the two images is compared and differences within a threshold are accepted
Mean squared error (MSE) with a threshold, which calculates the average squared difference across all pixels
Structural Similarity Index Measure (SSIM), which compares images based on perceived structural information
Perceptual hash comparison, which generates compact representations of images and compares those representations

The choice of algorithm involves trade-offs between computational performance, sensitivity to different types of errors, and the likelihood of false positives (detecting differences that are not actually safety-relevant) or false negatives (missing differences that are safety-relevant).

The algorithm selection process may involve generating a large set of test cases with generated acceptable and unacceptable differences, running candidate algorithms and thresholds on these test cases, and having human evaluators assess whether the algorithm's decisions are appropriate.

The comparison may be performed in various color spaces, such as RGB (red-green-blue), YUV (luminance and chrominance), or perceptual color spaces. The choice of color space affects which types of differences are emphasized. For automotive displays, differences in color are particularly important to detect, as color is often used to convey safety-critical information (e.g., red for warnings).

In practice, the thresholds are typically kept as simple as possible to minimize complexity and certification burden, with additional complexity added only if necessary to address performance challenges or unacceptable rates of false positives or false negatives.

### Option 1: Partial Frame Rendering

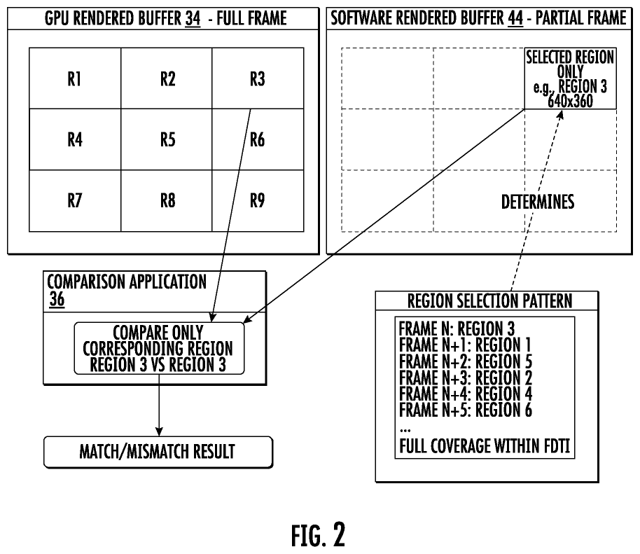

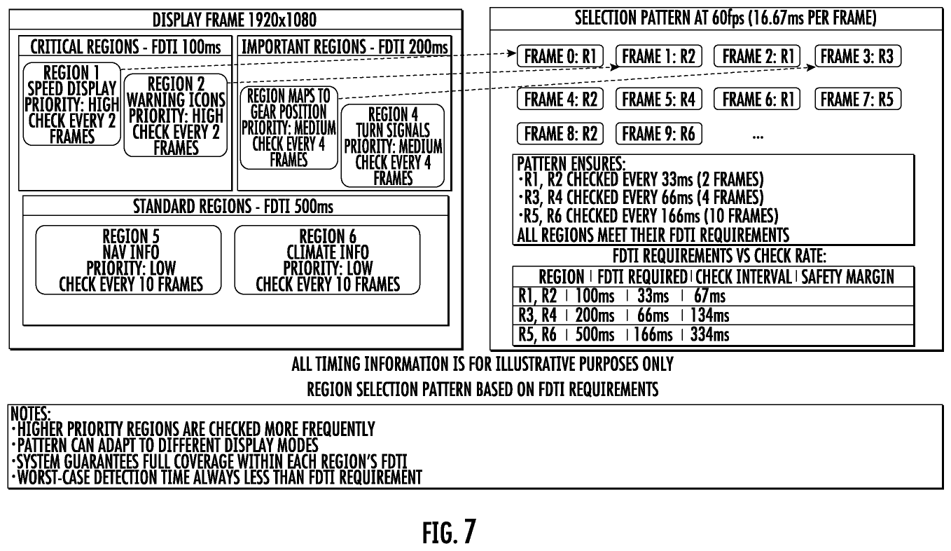

The first approach for addressing the performance disparity between GPU and software rendering is partial frame rendering, illustrated in FIGS. 2 and 7. In this approach, the SRA renders only a rectangular portion of the display for each frame, rather than rendering the entire frame. FIG. 2 Shows the timing of the HRA vs SRA frames while FIG. 7 shows how criticality of regions can be mapped to the timing. Specifically, a pattern is developed to ensure that each region is visited frequently enough to maintain the Fault Detection Time Interval (FDTI).

As shown in FIG. 2, while the GPU Rendered Buffer 34 contains the complete rendered frame with all graphical elements, the Software Rendered Buffer 44 contains only a selected rectangular region. The Comparison Application 36 compares only the corresponding region from the GPU Rendered Buffer 34 against the software rendered region.

The key to this approach is that the selected region changes for each frame according to a predetermined pattern. Over the course of multiple frames, the pattern ensures that every region of the display is rendered and verified within the specified FDTI.

The FDTI is a safety requirement that specifies the maximum time allowed between the occurrence of a fault and its detection. Different types of safety-critical information may have different FDTI requirements based on how quickly incorrect information could lead to a hazardous situation.

The region selection pattern, illustrated in FIG. 7, may be designed to visit regions with different frequencies based on their FDTI requirements. Regions displaying more critical information with shorter FDTI requirements are checked more frequently, while less critical regions may be checked less often. The pattern may also change based on the current display mode, as different modes may show different types of information in different locations.

For example, a region showing current vehicle speed might require checking every 100 milliseconds, while a region showing navigation information might only require checking every 500 milliseconds. The region selection pattern would be designed to meet both requirements.

The size of each rectangular region is typically fixed for a given display mode and is chosen based on several factors:
The performance of the software renderer (larger regions take longer to render)
The FDTI requirements (shorter FDTIs require more frequent checking, which may necessitate smaller regions)
The distribution of safety-critical content across the display
Memory and bandwidth considerations

The system mathematically guarantees full coverage within the FDTI by designing the region selection pattern based on measured or estimated rendering times. During system development, the rendering performance of the SRA 18 is characterized on the target hardware, and the region pattern is designed to ensure that even in worst-case scenarios, all required regions are checked within their FDTI requirements.

If actual rendering times at runtime are slower than expected, this could result in FDTI violations. Such situations are detected by the hardware Watchdog System 54, which monitors the update rates of both the HRA 16 and SRA 18 and triggers Failure Logic 56 if updates are not occurring frequently enough.

The partial frame rendering approach has several advantages:
It allows the SRA 18 to keep pace with the HRA 16 despite being much slower, by doing less work per frame
It provides flexibility to prioritize checking of more critical regions
It reduces memory bandwidth requirements compared to full frame rendering
It can adapt to different display modes with different content distributions

### Option 2: Full Frame Delayed Comparison

The second approach for addressing the performance disparity is full frame delayed comparison, illustrated in FIG. 5. In this approach, the SRA 18 renders complete frames, but at a much slower rate than the HRA 16. Comparison is performed between complete frames, but with a time delay.

When the HRA 16 renders a frame, a copy of the GPU Rendered Buffer 34 is made and stored, along with its associated Network Data Identifier. The SRA 18 begins rendering a complete frame based on the same input data. When the SRA 18 completes its rendering, which may take multiple HRA frame periods, the stored copy of the corresponding HRA frame is retrieved and compared against the SRA output.

This approach requires storing copies of HRA frames until the corresponding SRA frames are ready for comparison. Depending on the performance ratio between GPU and software rendering, multiple HRA frames may need to be stored simultaneously.

The buffer management for this approach may be implemented using shared memory, where the GPU 32 is configured to write its output to a shared memory region that can be accessed by the Comparison Application 36. To reduce memory requirements, the HRA frames may be scaled down or compressed when stored, particularly if the fuzzy comparison algorithm already operates on reduced-resolution images.

Many fuzzy comparison algorithms do not require full-resolution images. For example, an algorithm based on structural similarity might operate on images scaled down by a factor of 2 or 4, significantly reducing memory requirements while still detecting meaningful differences.

The full frame delayed comparison approach has different trade-offs compared to partial frame rendering:
It provides complete frame verification, which may be simpler to analyze for safety certification
It requires more memory to store HRA frame copies
It may result in longer minimum detection times for faults, as a complete SRA frame must be rendered before comparison
It does not provide the flexibility to prioritize different regions differently

The choice between Option 1 and Option 2 depends on the specific requirements and constraints of the application, including FDTI requirements, available memory, processing power, and the distribution of safety-critical content across the display.

### Failure Detection and Response

The system includes multiple mechanisms for detecting failures and responding appropriately, as illustrated in FIGS. 8 and 9. The primary failure detection mechanism is the image comparison between HRA and SRA outputs, but the system also includes watchdog monitoring to detect system-level failures.

When the Image Compare xx component determines that the difference between the GPU and software rendered buffers exceeds acceptable thresholds, it indicates a potential rendering error. The specific criteria for declaring a comparison failure depend on the chosen algorithm and thresholds but generally involve some measure of the magnitude and extent of differences.

The system 10 may distinguish between transient and persistent failures through filtering logic. A single frame comparison failure might be treated as a transient glitch and not immediately trigger failure logic, particularly if the FDTI allows time for multiple checks. However, repeated failures or failures in critical regions would trigger the Failure Logic more quickly.

The decision to filter transient failures must be carefully balanced against FDTI requirements. If filtering is used, the system must ensure that persistent failures are still detected within the required time interval.

When a failure is detected that exceeds the acceptable threshold (after any filtering), Failure Logic 56 is activated. The specific actions taken by the Failure Logic 56 are application-dependent, but in automotive displays, the typical response is to blank the display 22 to prevent showing potentially incorrect safety-critical information to the driver, while simultaneously rebooting the affected system.

The safety philosophy is that it is better to show no information than to show incorrect information. A blanked display 22 alerts the driver that there is a system problem, while incorrect information might be acted upon with dangerous consequences.

The Failure Logic 56 may also initiate other actions, such as:
Logging the failure for diagnostic purposes
Attempting to restart the rendering system
Switching to a backup display mode with reduced functionality
Alerting other vehicle systems of the display failure

The hardware Watchdog System 54 provides an independent monitoring mechanism that detects system-level failures that might not be caught by the comparison process. The Watchdog System 54 is a hardware timer that must be periodically “pinged” (reset) by the software system. If the Watchdog System 54 is not pinged within its configured timeout period, it automatically triggers the Failure Logic 56.

The Watchdog System 54 may monitor several aspects of system operation:
The update rate of the HRA 16, detecting if the GPU rendering has frozen or become too slow
The update rate of the SRA 18, detecting if the software rendering has frozen or become too slow
The progression of Network Data Identifiers, detecting if the system is stuck processing old data or repeatedly outputting the same frame
The operation of the Comparison Application 36 itself

The watchdog timeout values are configured based on the minimum FDTI for the data being displayed. The Watchdog System 54 must be able to detect failures within the FDTI to meet safety requirements.

The maximum time from error occurrence to Failure Logic 56 activation (the fault detection time) is determined by several factors:
The rendering time for the full SRA
The revisit rate for partial SRA frame rendering
The comparison processing time
Any filtering or debouncing applied to comparison results
The watchdog timeout period

This maximum detection time must be less than or equal to the specified FDTI for all safety-critical content being displayed.

### Safety Certification Considerations

The system architecture is specifically designed to enable safety certification while using non-certified graphics hardware. The certification strategy relies on several key principles:

First, all components that directly determine what should be displayed are certified to the required safety level (ASIL D for automotive applications). This includes:
The Stored 3D Content, created by a certified authoring tool
The 3D Content Instance, generated by certified code generation tools
The GL Studio SC Runtime, which is certified to ASIL D
The GL Studio SC Software Renderer, which is certified to ASIL D
The Image Compare component, which is certified to ASIL D
The Failure Logic, which is certified to the required level

Second, the non-certified components (the OpenGL ES Adapter, OpenGL ES Driver, and GPU) are treated as untrusted and are monitored by the certified components. Any failures in these components that affect the displayed output are detected by comparing against the trusted software-rendered output.

This is the fundamental insight of the invention: by using a trusted software renderer as a reference, the system can detect failures in untrusted hardware without requiring that hardware to be certified.

Third, the hardware independence between the HRA 16 and SRA 18 ensures that failures in the GPU 32 or its associated hardware do not affect the software renderer, allowing the comparison to detect such failures.

Fourth, the Watchdog System 54 mechanism provides defense-in-depth by detecting system-level failures that might not be caught by the comparison process, such as complete system hangs or performance degradation.

The GL Studio SC Software Renderer only needs to implement the subset of OpenGL SC functionality that is actually used by the GL Studio SC Runtime. This focused scope makes certification more practical. The runtime is designed to use only a well-defined subset of graphics operations that can be efficiently implemented and verified in software.

### Content Creation and Restrictions

The 3D content that can be displayed using this system is created using certified authoring tools such as GL Studio. The content creation process generates the Stored 3D Content 14, which includes all the graphical assets, scene structure, and behavior logic needed to render the display.

The only fundamental restriction on the content is that it must be render-able by both the HRA 16 and SRA 18. Since both use the same GL Studio SC Runtime, any content that can be created with the authoring tool and processed by the runtime can be displayed. This includes:
Arbitrary 3D geometry with complex shapes
Arbitrary 2D geometry including text and images
Textures and materials
Lighting and shading effects
Animations driven by time or data inputs
Dynamic positioning, rotation, and scaling of objects
Transparency and blending effects

The content may include both safety-critical (ASIL) and non-safety-critical (QM) elements. There are two approaches for handling mixed content:

In the first approach, both ASIL and QM content are included in the 3D Content Instance and rendered by both the HRA 16 and SRA 18. For display regions that only contain QM content in a particular mode, those regions may be skipped during verification, or they may still be checked (which provides additional verification even though it is not required for safety).

In the second approach, only ASIL content is rendered using the described system, and QM content is composited later in the display pipeline. For example, an ASIL-certified hardware compositor could be used to combine the verified ASIL content with separately rendered QM content, with the ASIL content rendered on top to ensure it is not obscured.

The choice between these approaches depends on the specific system architecture and the distribution of ASIL and QM content. The first approach is simpler but may waste verification resources on QM content. The second approach is more complex but provides clearer separation between safety levels.

Dynamic content, including animations and transitions, is handled naturally by the system. Both the HRA 16 and SRA 18 receive the same time value as part of their input data, and all animations are driven by this time variable. Since both renderers use the same time for the same animations, their outputs will match (within the tolerances of the fuzzy comparison) for every frame that is checked.

### Alternative Embodiments and Extensions

While the primary embodiment uses one HRA 16 and one SRA 18, alternative configurations are possible. Multiple software renderers could be used in parallel on separate CPUs or cores to address performance or FDTI challenges. By distributing the software rendering workload across multiple processors, the SRA 18 path could render more content or render more frequently.

For example, if a single software renderer can render one-tenth of the screen per frame, two software renderers could together render one-fifth of the screen per frame, allowing faster verification of the entire display.

However, using multiple HRAs 16 (multiple GPUs) is generally not advantageous for this application. Since only the GPU-rendered content is shown to the user, if any difference is detected, the only appropriate response is to trigger the Failure Logic. There is no benefit to voting logic, as there is no choice to be made about which output to display. Additionally, using two identical non-certified GPUs with identical drivers could result in common latent defects that would not be detected by comparison.

This contrasts with avionics applications, where multiple certified rendering systems might be used with voting logic to select the correct output. In the automotive context, the asymmetry between the fast GPU path (for display) and the slow software path (for verification) is fundamental to the cost-effective design.

A hybrid approach combining the present invention with traditional CRC-based verification is possible but adds complexity. Static or known elements could potentially use pre-calculated CRC checks, while dynamic 3D elements use the dual rendering approach. However, this reduces design flexibility and increases the complexity of the safety analysis.

The invention is not limited to OpenGL SC and OpenGL ES. The same principles could be applied to other graphics APIs, such as Vulkan, DirectX, Metal, or proprietary graphics interfaces. The key requirements are that there exists a software-implementable graphics API that can be certified, and that the hardware-accelerated path can be made to render the same content through a different implementation.

### Applications Beyond Automotive

While the detailed description has focused on automotive applications, the invention is applicable to other safety-critical display systems where similar constraints exist: the need to display complex 3D graphics, the cost constraints that prevent using fully certified graphics hardware, and the availability of a safe state (such as blanking the display) that can be entered when failures are detected.

Medical devices with graphical displays, such as surgical navigation systems or patient monitoring systems, could benefit from this approach. Industrial, Rail, and Agricultural control systems, particularly those with operator interfaces for controlling hazardous processes, are another potential application.

The invention may be less applicable to avionics, as noted in the disclosure, because the assumption of an easily achievable safe state may not hold. An aircraft in flight cannot simply blank its displays without creating a different hazard. Avionics systems typically require continued operation even in the presence of failures, which necessitates different architectural approaches such as triple-redundant certified systems with voting logic.

The invention is particularly well-suited to applications where:
Three-dimensional graphics with continuous parameters (position, rotation, scale) are needed
Pre-calculated verification approaches (like CRC) are impractical due to the state space size
Cost constraints prevent using fully certified graphics hardware
A safe fallback state (like blanking the display) is available and acceptable
Fault detection time intervals are long enough to accommodate software rendering performance

The present invention provides a practical and cost-effective solution for displaying three-dimensional (and two-dimensional) safety-critical graphical content in automotive and other safety-critical applications. By combining a fast GPU-based rendering path for display with a certified software rendering path for verification, the system enables the use of non-certified graphics hardware while maintaining the ability to detect rendering failures.

The dual rendering approach, combined with fuzzy image comparison and hardware watchdog monitoring, provides comprehensive fault detection within specified time intervals. The partial frame rendering optimization allows the system to meet stringent fault detection time requirements despite the performance limitations of software rendering.

The system architecture carefully balances safety requirements, performance needs, and cost constraints, making advanced 3D graphical displays practical for mass-market automotive applications where they were previously impractical or prohibitively expensive.

According to one or more embodiments, fuzzy comparison is used instead of an exact pixel comparison because the OpenGL standard does not guarantee an exact pixel representation from one renderer to the next. Since this approach uses two different renderers (the HRA and SRA), there is no guarantee that given the same input, that both renderers will generate the exact same pixels. Therefore, a fuzzy image comparison algorithm is utilized to ensure that what the user is shown is close enough to the expected output.

According to one or more embodiments, Failure Logic xx may be configured to blank the display of an automobile. The safety approach is to avoid showing wrong data by detecting the data is wrong and then hiding it, likely while rebooting the system.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Having thus described the disclosure of the present application in detail and by reference to embodiments thereof, it will be apparent that modifications and variations are possible without departing from the scope of the disclosure defined in the embodiments as follows:

We claim:

1. A data processing system configured for dual rendering verification of three-dimensional safety-critical graphical content, the system comprising:
a host computing system comprising:
one or more computers each with memory and at least one processor;
a display system; and
3D content stored within the memory of at least one of the one or more computers;
a first rendering path comprising a Hardware Rendered Application (HRA) for rendering 3D content using a graphics processing unit (GPU) to generate a first buffer;
a second rendering path comprising a Software Rendered Application (SRA) for generating a second buffer for comparison against the first buffer; and
a buffer comparison application that includes a fuzzy compare module for detecting discrepancies between the first and second buffers.

2. The system of claim 1, wherein the first rendering path and the second rendering path are independent hardware platforms.

3. The system of claim 1, wherein the first rendering path and the second rendering path are implemented on separate cores of the at least one processor.

4. The system of claim 1, wherein the first buffer is a buffer of color pixel values representing a rendered frame.

5. The system of claim 4, wherein the first buffer is stored within shared memory accessible to both the display system and the buffer comparison application.

6. The system of claim 1, wherein the first buffer is transmittable to the display system to display rendered content a user.

7. The system of claim 1, wherein the 3D content comprises arbitrary three-dimensional objects with variable positions, rotations, scales, and properties that change dynamically based on vehicle state.

8. The system of claim 1, wherein:
during runtime two separate instances of 3D content are created on the HRA and SRA respectively; and
the two separate instances each receive identical network data, which provides live information indicative of at least one of vehicle state, sensor readings, and navigation information.

9. A method of verifying three-dimensional safety-critical graphical content, comprising:
running two separate instances of three-dimensional safety-critical content stored within a memory of a host computing system;
generating a first buffer using a Hardware Rendered Application (HRA)
generating a second buffer using a Software Rendered Application (SRA)
comparing the second buffer to the first buffer;
identifying any discrepancies between the second buffer and the first buffer; and
if any discrepancies are identified, triggering a failure logic module.

10. The method of claim 9, wherein the HRA is part of a first rendering path and SRA is part of a second rendering path.

11. The method of claim 10, wherein the first and second rendering paths are independent hardware platforms implemented on separate cores of at least one processor of the host computing system.

12. The method of claim 9, wherein the first buffer is a buffer of color pixel values representing a rendered frame.

13. The method of claim 9, the first buffer is stored within shared memory accessible to both the display system and the buffer comparison application.

14. The method of claim 9, wherein the host computing system comprises a display system.

15. The method of claim 14, further comprising blanking the display system when the failure logic module is triggered.

16. A host computing system configured for dual rendering verification of three-dimensional safety-critical graphical content, the system comprising:
one or more computers each with memory and at least one processor; and
3D content stored within the memory of at least one of the one or more computers;
a first rendering path comprising a Hardware Rendered Application (HRA) for rendering 3D content using a graphics processing unit (GPU) to generate a first buffer; and
a second rendering path comprising a Software Rendered Application (SRA) for generating a second buffer for comparison against the first buffer.

17. The system of claim 16, further comprising a buffer comparison application that includes a fuzzy compare module for detecting discrepancies between the first and second buffers.

18. The system of claim 17, further comprising a display system configured to display alerts to a user during operation of an automobile.

19. The system of claim 17, further comprising a watchdog system configured to monitor operation of the buffer comparison application.

20. The system of claim 19, wherein the watchdog system comprises a hardware timer.
